(19) United States
(12) Patent Application Publication
(10) Pub. No.: US 2006/0072775 A1
(43) Pub. Date: Apr. 6, 2006

(54) Angle piece at hearing devices

(75) Inventor: Erich Dittli, Reichenburg (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 10/953,678

(22) Filed: Sep. 29, 2004

(51) Int. Cl. H04R 25/00

(52) U.S. Cl. 381/330

(57) ABSTRACT

At the exit of a hearing device (3) (for acoustic or sound-signals) a tube-like connecting-element or an angle piece (21) is arranged. At the end of the connecting element or angle piece (21) a thread (23) is arranged for connecting a tube (29) for sound or acoustic transmission of the hearing device into an ear-cannel.

The present invention refers to a hearing device in particular designed for being worn at the pinna or behind the ear respectively according to the wording of claim 1.

At the pinna or behind the ear worn hearing devices usually comprise at the exit for the acoustic signal so-called hearing angle means or an arcuated acoustic transmission element, respectively, on which an acoustic connection-tube is attached for the transmission of the signal or sound respectively into the auditory cannel. In existing hearing devices which comprise the mentioned hearing angle piece, also so-called hear-hook for the connection of the tube at the ear-adapter for sealing and the retention of the tube normally a flange is arranged at the ear-hook. To guarantee a firm connection of the tube at the ear-hook this flange usually is sharp-edged finished.

In particular for so-called power-hearing devices usually thicker transmission tubes are used, which can only be attached onto the hook by having widened first the end for attachment. This usually requires a specific gripper instrument. Furthermore, in case of removing this tube or also thinner standard tubes from the hook usually an additional problem occurs. The tube hardens usually and adapts to the flange or the sharp-edged angle respectively, and can only be removed from the hook by applying a great effort or by being destroyed respectively. Due to this reason very often the acoustic transmission tube as well as also very often the hook has to be changed completely. It is therefore an object of the present invention to propose a solution for the above mentioned problem.

Therefore, according the present invention proposed is a hearing device, in particular designed for being worn at the pinna or behind the ear comprising an angle piece or a hear-angle piece according to the wording of claim 1. According the present invention it is proposed, that at one end of the angle piece instead of a flange a thread is arranged which is suitable for the connection or the releasable firm attachment of the acoustic transmission tube at the angle piece or the hearing device respectively. By arranging a terminal thread the acoustic transmission tube can either be arranged by screwing at the angle piece as well as of course also by slipping onto the end-section, as it is done at conventional flanges of angle pieces. The advantage is that the removal of the tube is much easier as it is at conventional arranged flanges.

According a further aspect of the angle piece it is possible in addition-to the thread to arrange a cylindrical sealing surface to enhance the reliability of the sealing at the connection of the angle piece to the acoustic transmission tube.

Again, according a further aspect of the present invention it can be an advantage that the toward outside protruding outlines of the windings are not rounded but at least designed as an angle to guarantee a good retention of the tube at the connection to the angle piece.

Further preferred designs are characterised in dependent claims. The invention shall be further explained by examples and with reference to the attached figures. In that respect

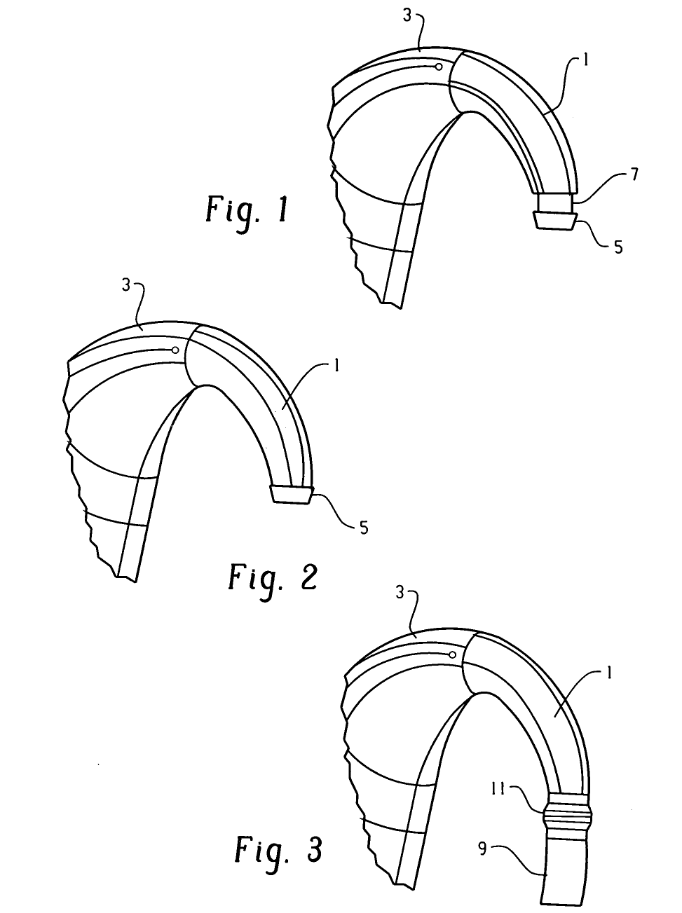

FIG. 1 shows a schematic view of an angle piece arranged at the hearing device comprising a conventional flange,

FIG. 2 shows a further conventional angle piece arranged at the hearing device,

FIG. 3 shows in schematic view an acoustic transmission tube attached to a conventional angle piece,

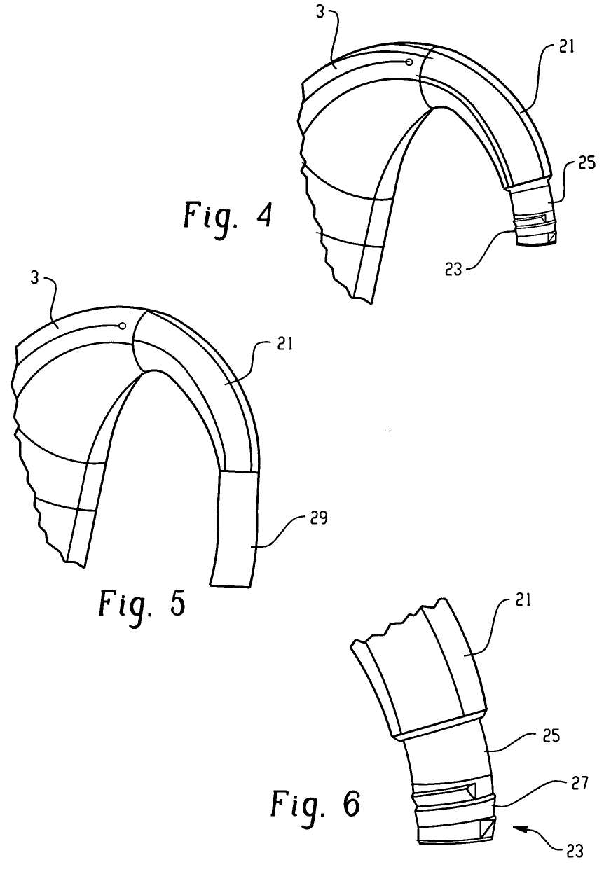

FIG. 4 shows an inventive angle piece at a hearing device comprising a terminal thread,

FIG. 5 shows schematically an acoustic transmission tube attached to the inventive angle piece and

FIG. 6 shows in enlargement a section of the terminal area of the hear-angle piece comprising the inventively proposed connecting thread.

FIG. 1 shows an angle piece 1 also so-called ear-hook for connecting an acoustic transmission tube to a hearing device 3. The conventional angle piece as known comprises at one end a flange 5 as well as a cylindrical sealing surface 7.

FIG. 2 shows in the same manner a conventional angle piece 1 as known at which however at the end only a flange 5 is provided without the sealing surface 7, as shown in FIG. 1.

FIG. 3 shows an acoustic transmission tube 9 attached to the terminal flange at which in the area of the flange of the angle piece 1 a bulb is shaped. Due to the sharp-edged design of the flange 5 as shown in the FIGS. 1 and 2 removing the tube 9 practically is not possible anymore without damaging or even destroying the latter.

Correspondingly and according the present invention it is proposed as shown in FIG. 4 schematically to provide a thread 23 at the angle piece or ear-hook 21 to which the acoustic transmission tube can be attached. Optionally it is possible to further provide a sealing surface 25 to create eventually an even better acoustic sealing at the area of the connection.

FIG. 5 again shows schematically an acoustic transmission tube 29 at the angle piece 21 which either can be thread on to the winding 23 or can be slipped on to the thread in a conventional manner. The great advantage of arranging a thread is that on one side the shaping of a bulb, as shown with reference to FIG. 3 does not occur and in addition removing the acoustic transmission tube 29 is essential easier, as this may be executed by easily screwing-off without the need of damaging or even destroying the tube. The same of course is valid also for the angle piece 21, which has not to be damaged or destroyed for removing the tube.

The connection of the angle piece 21 itself to the hearing device 3 can be done in a conventional manner and therefore is not an object of the present invention. In other words the angle piece 21 can be slipped onto a projection or can be screwed onto a winding at the hearing device 3.

FIG. 6 finally shows in a sectional view the terminal thread 23 at the angle piece 21. According one aspect it is possible to design the individual windings 27 angle-like or as sharp edges to effectively prevent the tube being removed after attachment. Again, as shown in FIG. 6 it is possible to provide a sealing surface 25 between the thread and the wall of the angle piece 21.

The angle piece and ear-hook as shown with reference to FIGS. 4 to 6 is of course only a possible design example and the present invention is by no means limited to the views in the mentioned figures. In particular it is possible to design the terminal thread in any possible manner whereby preferably it should be taken into consideration, that by the chosen angle-form a simple removing of the attached acoustic transmission tube can be prevented. The materials used for the hearing-angle or angle piece respectively are no topic of the present invention and all materials as known in the state of the art are usually suitable for the production of the inventive hearing-angle or angle piece respectively.

1. Hearing-device in particular suitable for being worn at the pinna or behind the ear, respectively, comprising an exit for acoustic-or sound-signals respectively, characterized in, that at the exit a tube-like connecting-element the exit with a tube (29) for the sound or acoustic transmission in or to an ear-cannel the connecting-element or angle piece (21) respectively, has a thread (23) at one end for the attachment of the tube (29).

2. Hearing device according claim 1 characterized in, that between the thread (27) and the wall of the connecting element or angle piece (21) respectively a sealing-surface (25) is arranged.

3. Hearing-device according to one of the claims 1 or 2 characterized in, that the contours of the windings protruding towards outside are at least almost angle-like or sharp-edged.

4. Angle piece or ear-hook (21) respectively suitable for a hearing-device according to one of the claims 1 to 3 in particular suitable for connecting of standard-acoustic transmission tubes as well as for acoustic transmission-tubes for the connection to so-called power-hearing-devices.

5. Process for the connection of an acoustic transmission tube (29) to an angle piece or ear-hook (21) respectively of a hearing device (3) characterized in, that the end of the tube is screwed onto a thread arranged at the end of an angle piece.
